(19) United States
(12) Patent Application Publication
(10) Pub. No.: US 2013/0178966 A1
(43) Pub. Date: Jul. 11, 2013

(54) Method and System for Identifying a Media Program From an Audio Signal Associated With the Media Program

(71) Applicants: Geir Magnusson, JR., Wilton, CT (US); Riley Joseph Berton, Bordentown, NJ (US)

(72) Inventors: Geir Magnusson, JR., Wilton, CT (US); Riley Joseph Berton, Bordentown, NJ (US)

(73) Assignee: Function(x), Inc., New York, NY (US)

(21) Appl. No.: 13/345,942

(22) Filed: Jan. 9, 2012

(51) Int. Cl. G06F 17/00

(52) U.S. Cl. 700/94

(57) ABSTRACT

A method of identifying a media program from its associated audio signal comprising dividing a portion of the range of human-audible frequencies in a quasi-logarithmic fashion into a plurality of spectral bands; recording a segment of predetermined length from the audio signal at a predetermined interval to obtain a plurality of analog audio samples, the predetermined interval being a fraction of the predetermined length; converting each analog audio sample to a plurality of digital audio samples at a first sampling rate; creating a frequency domain representation of each digital audio sample; determining spectral energy within each spectral band for each digital audio sample; reflecting whether the spectral energy within each spectral band went up between adjacent ones of the plurality of digital samples as a Boolean array; and representing the audio signal with a predetermined number of Boolean arrays. A confidence score for each value can then be calculated.

### BACKGROUND

1. Field of the Invention

The present invention relates to systems and methods for identifying various media and entertainment (e.g. broadcast TV, on-demand TV, games, live entertainment, movies, and radio) programs from an audio signal associated with the programs.

2. Description of the Related Art

Over the past two decades there has been huge growth in the number of in-home entertainment options. Much of this growth has been driven by cable and satellite television, which not only provides more broadcast channel options than traditional over-the-air broadcast television could provide, but also provides the ability to view programming on demand. This on demand programming includes some of the same content (e.g. movies, sporting events, news, talk shows, dramatic series, comedy series, documentaries, family programming, educational programming, and reality programming). While some of this content is pay-per-view, much of the content is still supported by the sale of commercial advertising interspersed during the content.

Over the past decade there has also been significant growth in various in-home entertainment options, including but not limited to broadcast TV, on-demand programming, gaming (particularly online games), online video and radio. Taking radio as an example, over the past few years the addition of paid satellite radio programming, new technologies, such as HD radio, have expanded the offerings that can be made available well beyond the stations that could be provided on AM and FM radio.

As a result of this proliferation of entertainment choices, there is a desire in the media and entertainment industry to attract viewers/listeners, which may also be referred to herein as media and entertainment consumers or just consumers, to consume (i.e. listen and/or watch) content. There is an associated desire in the media and entertainment industry to retain viewers.

Notwithstanding the proliferation of media and entertainment options there is still a limit to the amount of content and commercial advertising that can be provided. Consequently, content providers have been looking for additional outlets to connect to their viewers. Among other things, content providers have been trying various means to use the Internet and other social media, such as Facebook® and Twitter®. Most of these means have involved connecting the viewers with one another to discuss programming and other media-related interests via social networks and destination websites where the viewers may consume additional content and be exposed to additional advertising.

However, these traditional media attempts at Internet and social media offerings have required too much effort for viewers to access. Moreover, these attempts have not been sufficiently interactive to attract users in a systematic way. Consequently, there is a need for a system and method that will simplify the identification of media and entertainment programming.

There have been a number of systems and methods proposed for identifying such programming including embedding a variety of fingerprint schemes within the original programming. Those systems and methods require the distribution and tracking of such fingerprints making their use cumbersome and potentially difficult to manage.

Other systems and methods have been developed that use the actual audio signal from the programming to identify the programming. However, most, if not all of those schemes require too much audio to identify the programming and often require a significant amount of processor time making those schemes less desirable to implement, especially on a distributed computing basis. Consequently, there is a need for a system and method for identifying media and entertainment programs from their associated audio signal so as to more quickly engage viewers and encourage them to interact with additional outlets in association with their media and entertainment viewing interests.

Over the last few years, the adoption of smart phones has accelerated particularly within highly desirable demographics for media and entertainment providers, content providers, and advertisers. Smart phones provide cellular telephone audio, SMS messaging, MMS messaging, data services, and sufficient processor power to run computer applications. There are many smart phone manufacturers who design smart phones and other devices for use with a variety of complex operating systems including, but not limited to, Android, Blackberry OS, iOS, Windows Mobile 7, and WebOS. Because smart phones are used regularly in daily life they provide an opportunity for advertisers and marketers. This opportunity, however, has been under-utilized, particularly to harness viewers for media content providers in part because of the shortcomings identified above. Accordingly, there is a need for a system and method for identifying media and entertainment programs from their associated audio signal especially on a distributed computing basis.

### SUMMARY OF DISCLOSURE

The present disclosure teaches various inventions that address, in part (or in whole) these and other various desires in the art. Those of ordinary skill in the art to which the inventions pertain, having the present disclosure before them will also come to realize that the inventions disclosed herein may address needs not explicitly identified in the present application. Those skilled in the art may also recognize that the principles disclosed may be applied to a wide variety of techniques involving communications, marketing, reward systems, and social networking

The present disclosure teaches, among other things, a method of substantially identifying a media program from its associated audio program signal, wherein the audio program signal is a substantially continuous time-domain signal generally having a range of frequencies normally audible to humans. The method generally comprises: (a) dividing a substantial portion of the range of human-audible frequencies (e.g. 300 Hz to 4 kHz) in a quasi-logarithmic fashion into a plurality of spectral bands; (b) recording a segment of predetermined length (e.g. one second) from the audio program signal at a predetermined interval (e.g. eight milliseconds) to obtain a plurality of analog audio program samples, the predetermined interval being a fraction of the predetermined length; (c) converting each of the plurality of analog audio program samples to a plurality of digital audio program samples at a first sampling rate; (d) creating a frequency domain representation of each of the plurality of digital audio program samples (which may comprise calculating a Fast Fourier Transform from each of the digital audio program samples); (e) determining spectral energy within each of the plurality of spectral bands for each of the plurality of digital program samples; (f) reflecting whether the spectral energy within each of the plurality of spectral bands went up between adjacent ones of the plurality of digital program samples as a Boolean array; and (g) representing the audio program signal with a predetermined number of Boolean arrays. Where the first sampling rate is 48 kHz, the method may further include down-sampling the plurality of digital audio program samples to a second sampling rate, such as 8 kHz.

The method may further comprise comparing a portion of the predetermined number of Boolean arrays to arrays created from a plurality of media programs until the media program is found. With a large enough number of samples, absolute matching may not be required to find the correct media program. Even where absolute matching is not required, the match may not be close enough to confirm the correct media program. Because that may be due errors in recording (and elsewhere), the method may further include calculating a confidence score for each value in the Boolean array, wherein the confidence score is a function of the difference between adjacent spectral energy values; and further representing the audio program signal with the confidence score. Where such confidence scores are available, the method may further include comparing a portion of the predetermined number of Boolean arrays to arrays created from a plurality of media programs until the media program is found; and flipping a value within the Boolean arrays where the confidence score associated with the value is below a predetermined threshold and the media program has not been found.

The invention may also alternatively comprise a system for substantially identifying a media program from its associated audio program signal, wherein the audio program signal is a substantially continuous time-domain signal generally having a range of frequencies normally audible to humans. The system comprising: means for dividing a substantial portion of the range of human-audible frequencies (e.g. 300 Hz to 4 kHz) in a quasi-logarithmic fashion into a plurality of spectral bands; an audio segment recorder for recording a segment of predetermined length (e.g. one second) from the audio program signal at a predetermined interval (eight milliseconds) to obtain a plurality of analog audio program samples, the predetermined interval being a fraction of the predetermined length; an analog-to-digital converter to convert each of the plurality of analog audio program samples to a plurality of digital audio program samples at a first sampling rate; means for creating a frequency domain representation of each of the plurality of digital audio program samples (which may comprise calculating a Fast Fourier Transform from each of the digital audio program samples); and means for reflecting as a Boolean array whether the spectral energy within each of the plurality of spectral bands for each of the plurality of digital program samples increased between adjacent ones of the plurality of digital program samples.

The system may further comprise means for comparing a portion of the predetermined number of Boolean arrays to arrays created from a plurality of media programs until the media program is found. With a large enough number of samples, absolute matching may not be required to find the correct media program. Even where absolute matching is not required, the match may not be close enough to confirm the correct media program. Because that may be due errors in recording (and elsewhere), the system may further comprise means for calculating a confidence score for each value in the Boolean array as a function of the difference between adjacent spectral energy values and for storing the confidence score in association with the Boolean array. Where such confidence scores are available, the system may further comprise means for comparing a portion of the Boolean arrays to arrays created from a plurality of media programs until the media program is found; and means for flipping a value within the Boolean arrays where the confidence score associated with the value is below a predetermined threshold and the media program has not been found.

At its most basic level, consumers initially download a simple free application to their mobile phone, tablet, or laptop, consumers place their app-enabled mobile phone (or any other device) in front of them while watching television or otherwise receiving media content; the app captures audio from the media programming; the captured audio is analyzed and matched via a network; and feedback is provided to the consumer based on the captured audio.

The present method and system provides an approach to quickly identifying the programming with low overhead. These and other advantages and uses of the present system and associated methods will become clear to those of ordinary skill in the art after reviewing the present specification, drawings, and claims.

### BRIEF DESCRIPTION OF THE FIGURES

FIG. 1 illustrates one embodiment of a system in accordance with one approach to the present invention.

FIG. 2 illustrates some of the details associated with the audio identification engine of the system illustrated in FIG. 1.

FIG. 3 illustrates some of the details associated with the viewer feedback engine of the system illustrated in FIG. 1.

FIG. 4 illustrates one potential user interface approach to a “get started” screen in the installed application that may be used in association with an exemplary smart phone.

FIG. 5 illustrates one user interface approach to a “an audio check in” screen in the installed application that would preferably be used in association with the computer application deployed on the exemplary smart phone of FIG. 4.

FIG. 6 illustrates one user interface approach to a “checked in” screen in the installed application that may be used in association with the exemplary smart phone of FIG. 4.

FIG. 7 illustrates a flow diagram of a method of audio check-in verification that may be used in association with one embodiment of the system illustrated in FIG. 1.

FIG. 8 illustrates a flow diagram of a method of substantially identifying an audio program signal.

FIG. 9 illustrates one example of an audio program signal associated with a media or entertainment program being sampled at the periodic sampling rate T.

FIG. 10 illustrates one approach to dividing a substantial portion of the range of human-audible frequencies in a quasi-logarithmic fashion into a plurality of spectral bands.

FIG. 11 illustrates one approach to recording segments of predetermined length from the audio program signal at a predetermined interval.

### DETAILED DESCRIPTION

The present invention provides a system and method that can be utilized with a variety of different client devices, including but not limited to desktop computers and mobile devices such as PDA's, smart phones, cellular phones, tablet computers, and laptops, to identify media and entertainment programs from their associated audio signals. Thus, while the invention may be embodied in many different forms, the drawings and discussion are presented with the understanding that the present disclosure is an exemplification of the principles of the inventions disclosed herein and is not intended to limit any one of the disclosed inventions to the embodiments illustrated.

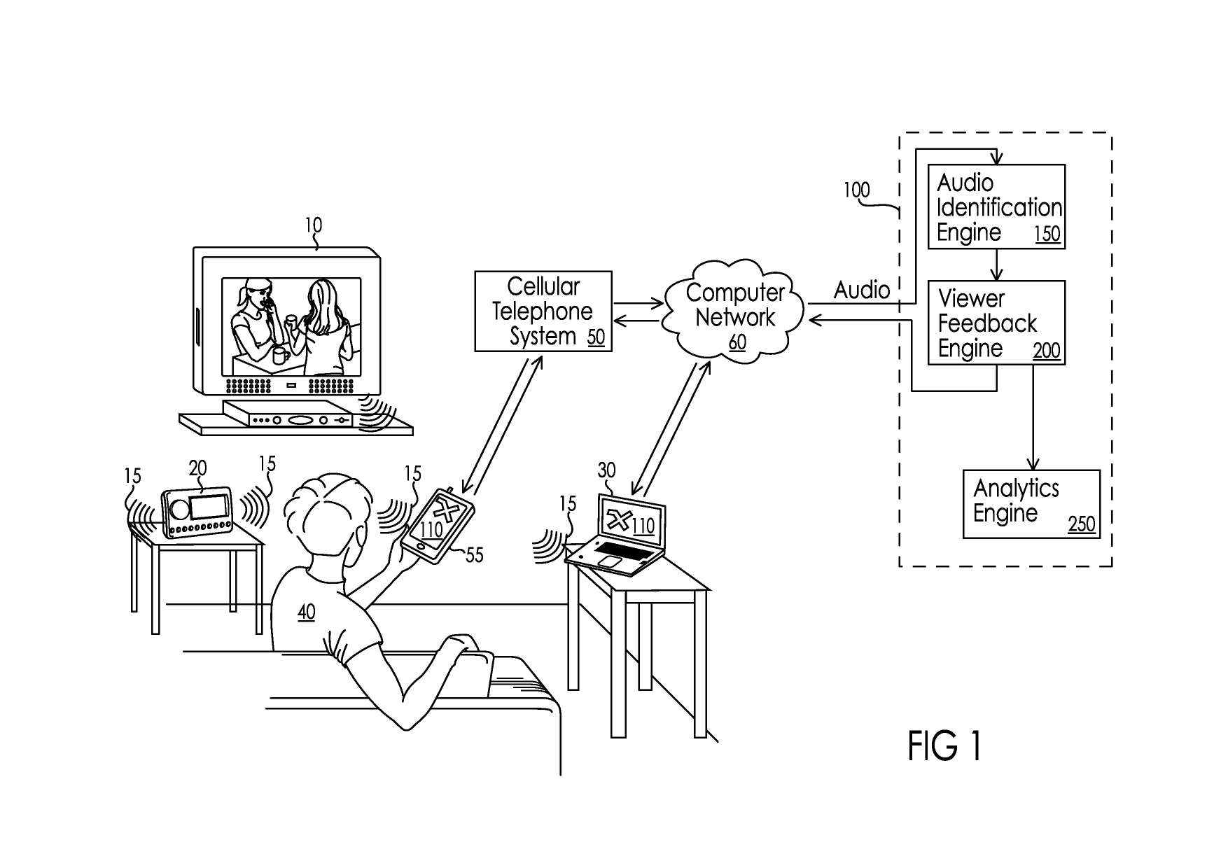

FIG. 1 illustrates one embodiment of a system 100 and its potential avenues for interaction with the real world toward implementing the concepts of the present invention. In particular, system 100 communicates with viewer 40 via a computer application 110 that has been installed on the smart phone 55 in viewer's hand. System 100 may also communicate with viewer 40 via SMS, MMS, push notification, and other types of messaging (not shown) that are or may become available on smart phone 55. Although the specification will continue to speak in terms of smart phone 55, it should be understood by those of ordinary skill in the art having the present specification, drawings, and claims before them that in some approaches to the present invention it would be possible to utilize any telephone or even computer that can capture audio for transmission into system 100.

The smart phone 55 is connected to the system 100 via a cellular telephone system 50 and computer network 60. The cellular telephone system 50 may be any type of system, including, but not limited to CDMA, GSM, TDMA, 3G, 4G, and LTE. To facilitate the use and bi-directional transmission of data between the system 100 and smart phone 55, the cellular telephone system 50 is preferably operably connected to computer network 60 in a variety of manners that would be known to those of ordinary skill in the art.

System 100 may further communicate with viewer 40 via computer 30 that is operably connected to the system 100 via the computer network 60. The computer network 60 used in association with the present system may comprise the Internet, WAN, LAN, Wi-Fi, or other computer network (now known or invented in the future). It should be understood by those of ordinary skill in the art having the present specification, drawings, and claims before them that the computer network 60 may be operably connected to the computer 30 over any combination of wired and wireless conduits, including copper, fiber optic, microwaves, and other forms of radio frequency, electrical and/or optical communication techniques.

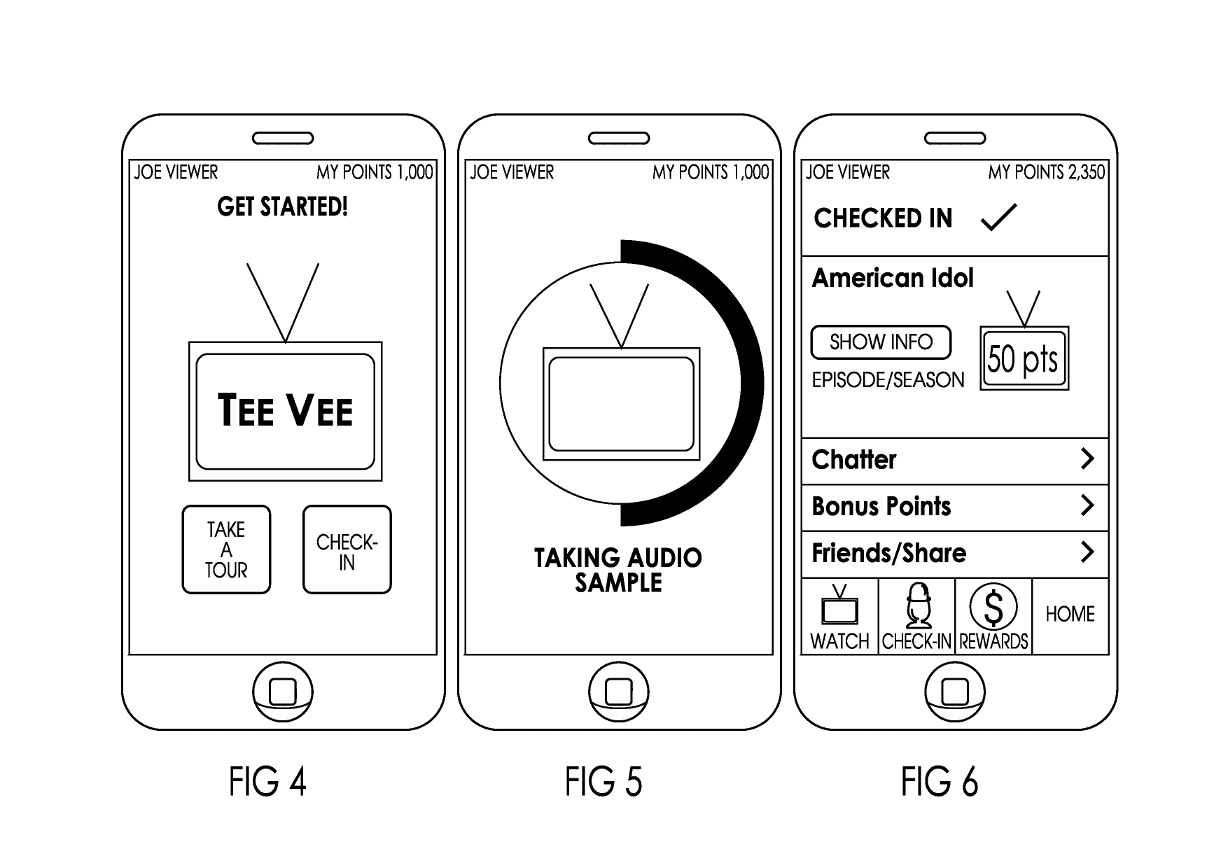

As shown in FIG. 1, a fundamental concept is that some device, such as smart phone 55 is exposed to the ambient audio 15 that viewer 40 is currently experiencing. For instance, FIG. 1 depicts the viewer 40 listening to a television 10 and a radio 20. The television 10 may be broadcasting live television programming that was delivered to the television 10 from various sources, such as cable set top box or satellite receiver 11, DVD or BluRay disks (not shown), or from a digital video recorder (DVR), which may be incorporated into set top box/receiver 11. The radio 20 may be broadcasting AM, FM, HD radio and/or satellite radio programming into the living room of viewer 40. As illustrated in FIG. 5, when the computer application 110 (previously installed on smart phone 55) is activated, it will record (or otherwise capture) a segment of predetermined length of the ambient audio 15, which will include an audio program signal from the television and/or radio program playing near the viewer 40. Alternatively, the application 110 may be continuously running, but only record or otherwise obtain an audio segment after the viewer 40 presses a “Check-In” button on the user interface, such as the example user interface illustrated in FIG. 4. The captured audio segment is used to determine the identity of the media program as discussed hereinbelow. FIG. 5 illustrates a potential user interface that may appear while the system is trying to determine that identity. If the audio program is successfully matched to a known media program, then the viewer is notified of the successful check-in (see, e.g. FIG. 6). If the audio segments recorded by the system were insufficient to provide a successful match, then the viewer would be notified of the non-match. If there is a non-match, the viewer may be given an opportunity to try matching again (by obtaining new audio segment(s).

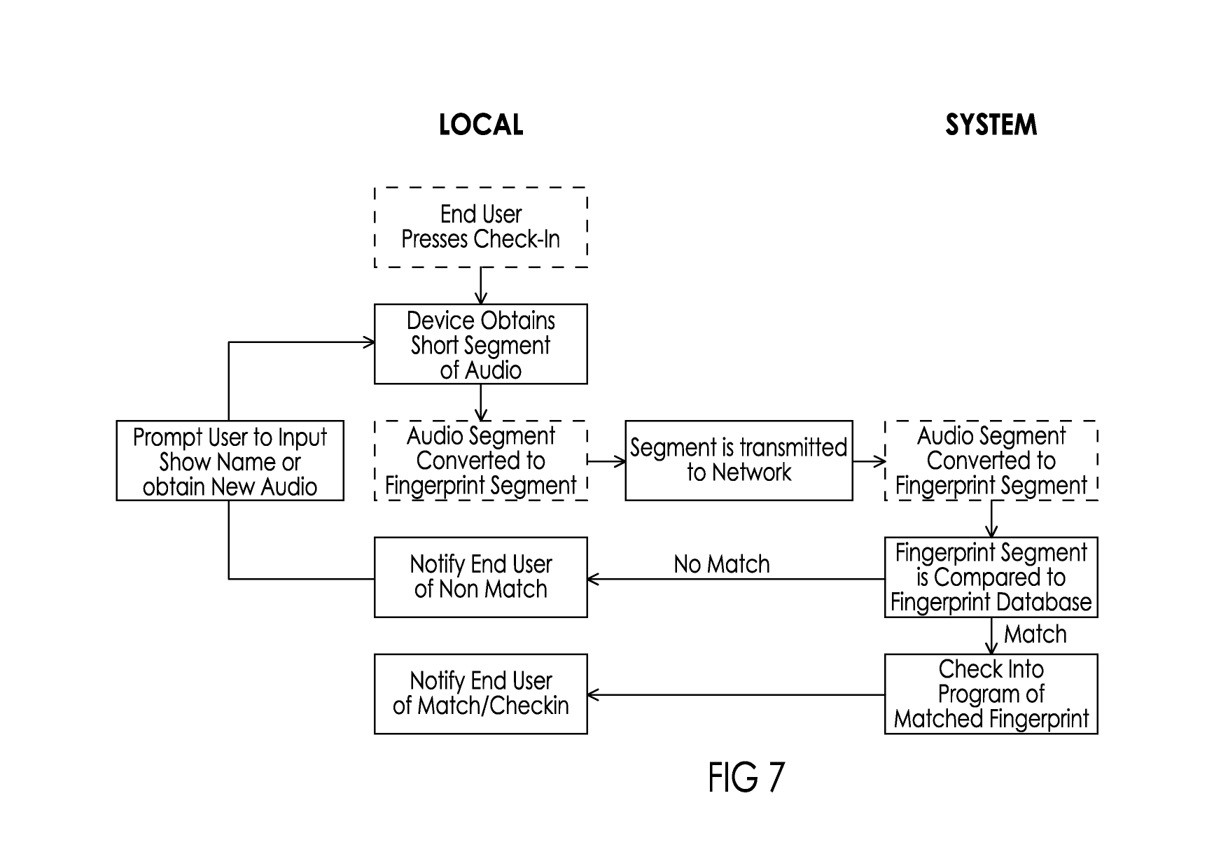

Returning to FIG. 1, computer 30 may be any type of computer, such as desktop, laptop, or tablet computer that can preferably operably connect to the computer network 60. Computer 30 should include a video display and a browser capable of rendering content from social media sites such as Facebook® to enhance the viewer experience in interacting with the system 100. Computer 30 may also have the computer application 110 installed thereon. The computer application 110 installed on the computer 30 may be a different or the same application that is installed on smart phone 55. It is possible for computer application 110 to have a slightly different look and feel on computer 30 than on smart phone 55 because of the additional screen space, however, it is preferred that the look and feel be sufficiently similar to invoke the same feeling in the viewer with respect to the interaction with the system 100. As such, computer application 110 on the computer 30 could also be used to check into shows in the manner described with respect to FIG. 7 above.

System 100 includes the computer application 110 and an audio identification engine 150, and may further include a viewer feedback engine 200 and an analytics engine 250. Computer application 110 may be pre-installed on computer 30 and/or smart phone 55. However, after viewers learn about system 100, it is primarily contemplated that the viewer 40 may download the computer application 110 from one of a variety of sources including, but not limited to the iTunes® AppStore, Android® application marketplace or a dedicated website. It is alternatively contemplated that the viewer 40 may send an email to a dedicated website and receive, in return, a copy of the computer application 110 for installation. It is also contemplated that the viewer 40 may send a predetermined SMS message to an enumerated short code (e.g. Send JOIN to 55512) and receive instructions for interacting with system 100 via a return SMS message. Finally, it may be possible for viewer 40 to register on the website without downloading the computer application 110. In such a case the application 110 may be invoked from the website (or otherwise in the cloud).

It should be understood that computer application 110 will be used to, among other things, record (or otherwise capture) a segment of ambient audio 15 of predetermined length including the audio program associated with the media program the viewer is watching. While computer application 110 has been illustrated as being wholly resident on smart phone 55 and/or computer 30 of each viewer 40, it should be understood by those of ordinary skill in the art having the present specification, drawings, and claims before them it is contemplated that the various aspects of system 100 may be deployed across the globe in the cloud or on a plurality of servers, which may provide redundant functionality to allow quicker—substantially real-time—processing of the segments of ambient audio 15 of predetermined length that are being captured or otherwise recorded by computer application 110. In fact, it should be understood that even though various aspects of system 100, including, but not limited to, the audio identification engine 150, have been illustrated as being singular and co-located at a central location with other aspects of the system to avoid obscuring the invention, certain aspects of system (and particularly the audio identification engine 150) could even be deployed onto the smart phone 55 and/or computer 30 of each viewer 40.

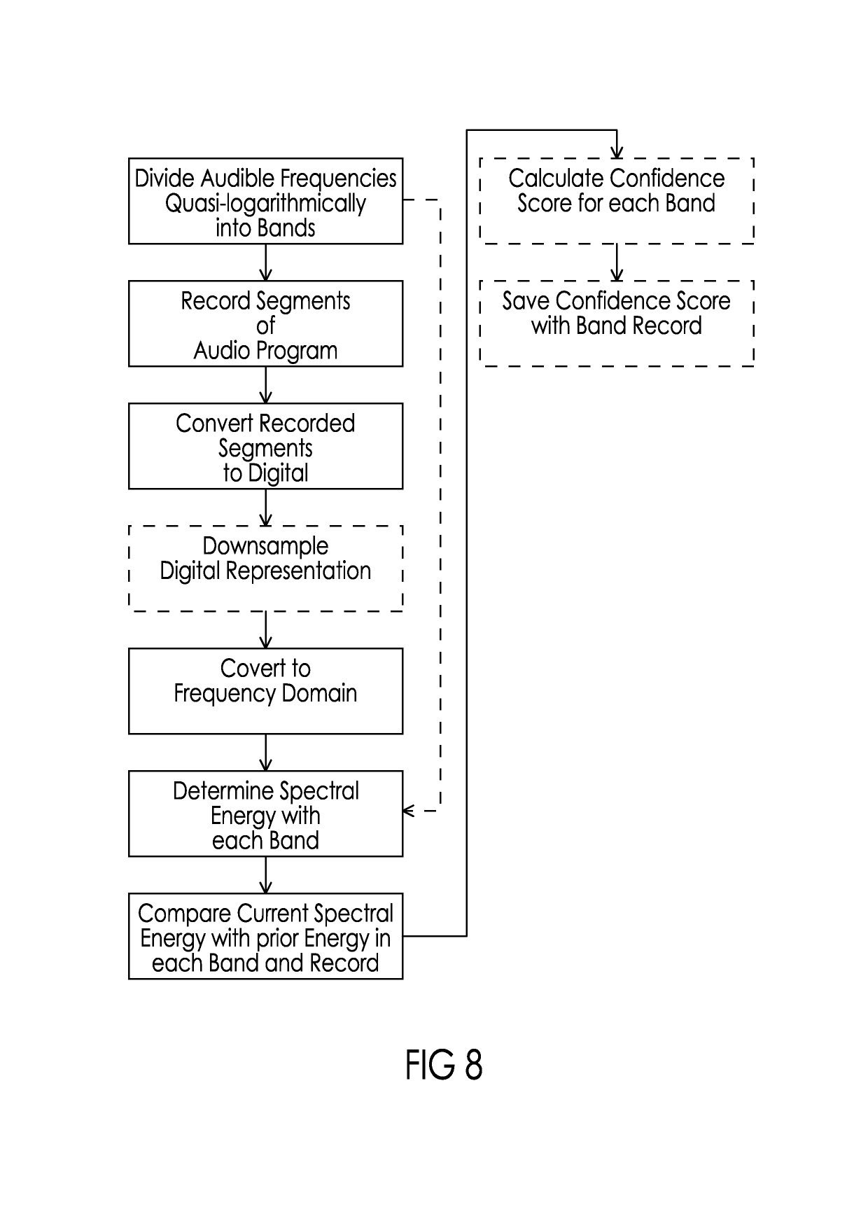

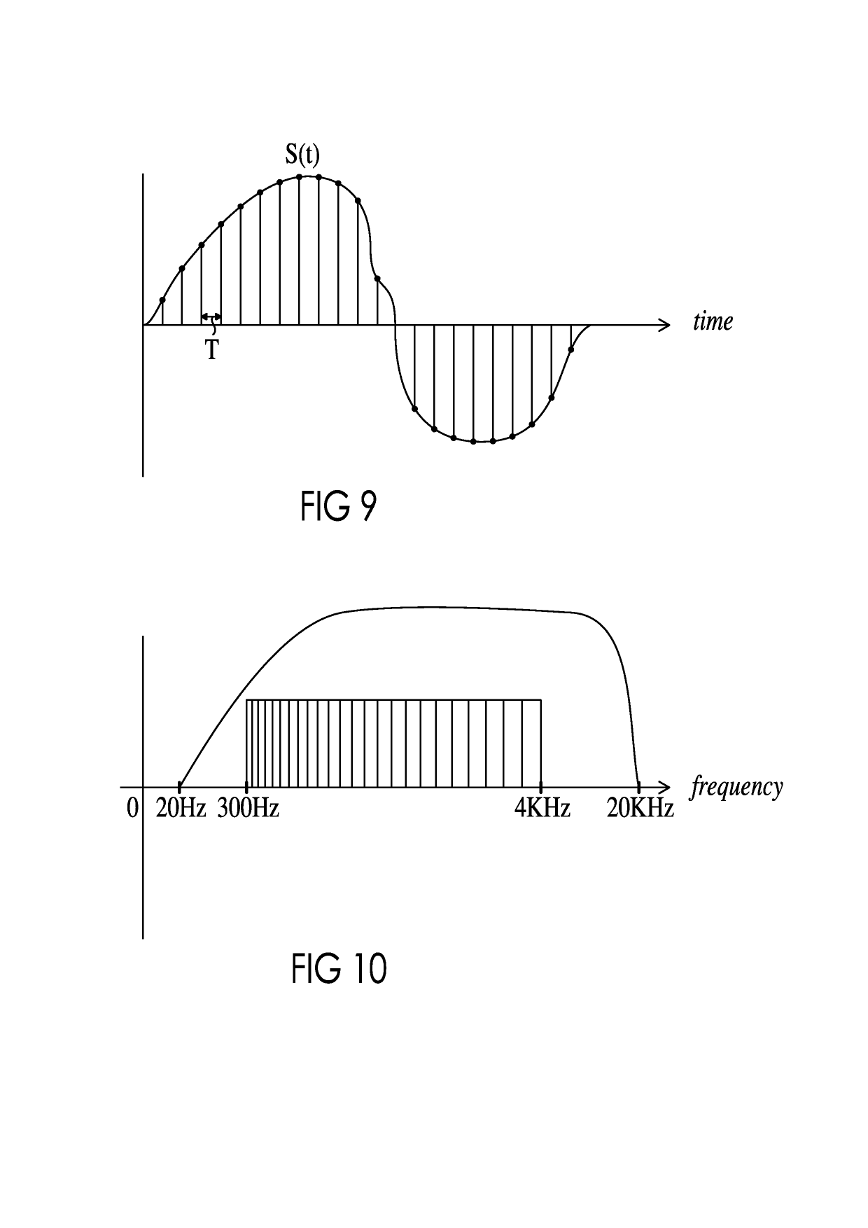

The audio identification engine 150 manipulates the recorded audio segment essentially converting it from an audio signal to an audio fingerprint. In the present case, the audio fingerprint is comprised of a predetermined number of arrays containing Boolean values and may further include confidence values associated with one or more of the Boolean values. The Boolean and confidence values are determined in accordance with the methodology illustrated in FIG. 8. In particular, the method includes dividing a substantial portion of the range of human-audible frequencies in a quasi-logarithmic fashion into a plurality of spectral bands. One example of such a division of the range is shown in FIG. 10.

In the example illustrated by FIG. 10 the range of 300 Hz to 4,000 Hz (i.e. 4 kHz) has been divided into twenty-four continuous bands (i.e. with no gaps between the bands). As is known, the human-audible frequency range may be thought to extend as low as 20 Hz and as high as 20,000 Hz (i.e. 20 kHz). So, the range illustrated in FIG. 10 reflects a substantial portion of the range of human-audible frequencies, it being understood that the range may be changed to accommodate different designs, systems, and theories of operation with a greater range requiring more processing and a smaller range presenting an increased risk of misidentification of the media program associated with the audio program signal.

The example of FIG. 10 has also been illustrated as having been divided into twenty-four spectral bands. While twenty-four is a preferred number of bands for the selected range of frequencies illustrated, it is contemplated that the number of bands over the same range of human-audible frequencies can range from eight (8) to thirty-two (32). As depicted in FIG. 10, the widths selected for each of the twenty-four bands increases as the frequency increases, such that the number of frequencies found within a spectral band near 300 Hz are fewer than the number of frequencies that would be included within the bands near 4 kHz. Among other things, this width variation leads toward a more even distribution of spectral energy inasmuch as the energy injected into the system by lower frequencies is greater than the energy injected into the system by higher frequencies. The division scheme depicted in FIG. 10 particularly illustrates the use of a quasi-logarithmic function for determining the band widths of each spectral band from the low frequencies to the high frequencies. Thus, the widths of adjacent bands may be recursively defined as follows:

w₁−w₀+log(w₀)

where w₀ is the width of the band to the left of a pair of spectral bands. So, if the width of the spectral band beginning at 300 Hz in the present example were 2 units, then the width of the next adjacent band to the right would be 2.3 units. And the third band would then be calculated as roughly 2.66 units, as follows:

2.3+log(2.3)

Various other quasi-logarithm schemes may be used with the understanding that a quasi-logarithmic scheme roughly models human auditory performance over the audible range.

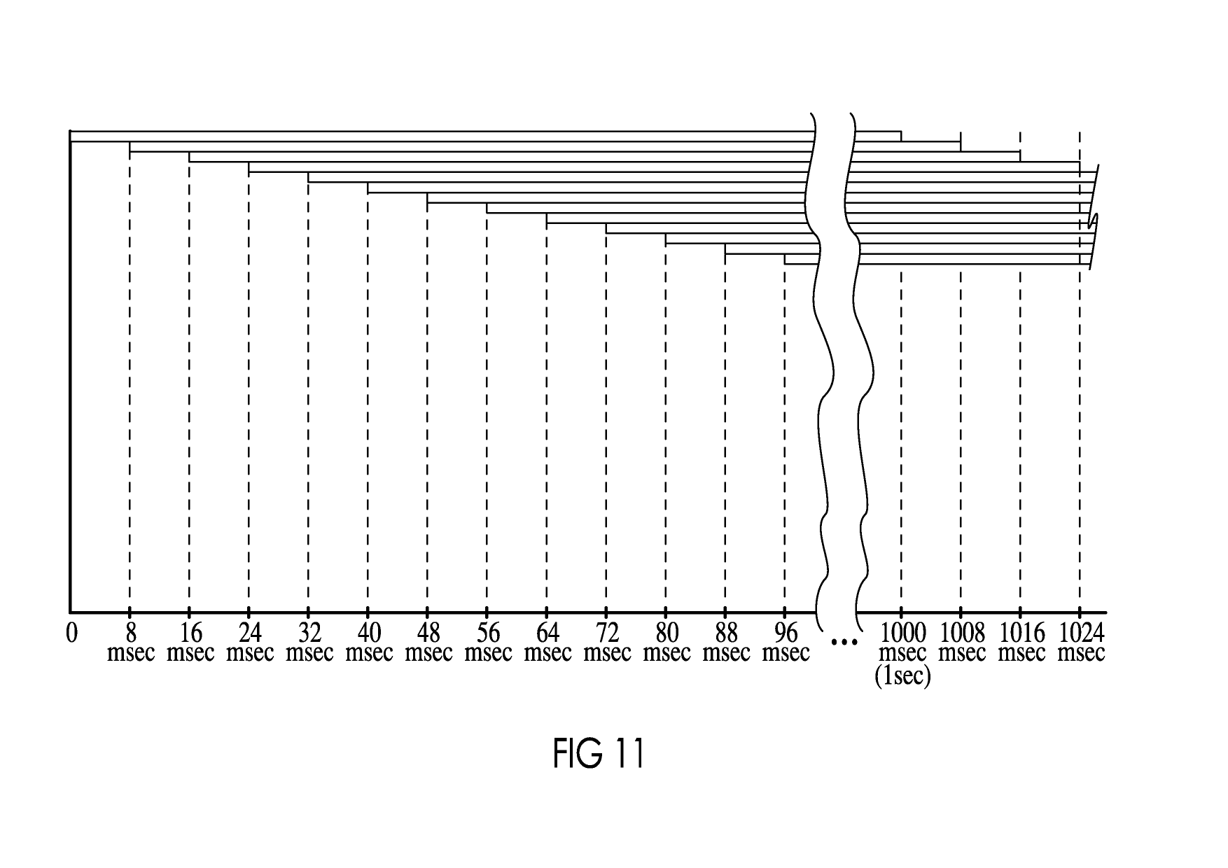

Returning to the method of FIG. 8, the method further includes recording a segment of predetermined length from the audio program signal at a predetermined interval to obtain a plurality of analog audio program samples. In the illustrated embodiment, the audio will converted to a digital representation having a sampling rate of 8 kHz. One particular embodiment of this recording is shown in FIG. 11, where the predetermined length of each audio segment is one (1) second and the predetermined interval between samples is eight (8) milliseconds (or 8/1000^{th} of a second). With these values, one hundred and twenty (125) one-second samples may be captured every three seconds. These selected values accommodate a 2048-point fast Fourier Transform (such as the FFT Accelerate API provided as part of iOS by Apple Computer of Cupertino, Calif.), which requires the input of two thousand forty-eight (2048) samples over roughly ¼ second at 8 kHz sampling rate. Finally, by choosing the predetermined interval between samples as eight milliseconds, when comparing two fingerprints made with this technique the prints can be no more than 4 milliseconds skewed from each other. As the interval is spread from eight to nine milliseconds the bit-to-bit error rate may increase by as much as forty percent.

Returning to FIG. 8, each of the plurality of analog audio program samples is converted into a plurality of digital audio program samples by an analog to digital converter at a first sampling rate. As discussed above the desired sampling rate is 8 kHz, however, initial sampling rates for audio conversion are generally 48 kHz, given the preferred parameters discussed above, in such instances, the digital representation of the audio program sample would be preferably down-sampled to 8 kHz.

As shown on FIG. 8, each of the plurality of digital audio program samples are then converted to their frequency domain representation. This is commonly done using fast Fourier Transforms (or FFT). There are a variety of FFT algorithms and available FFT API's available in the marketplace. Any of these algorithms and/or APIs would work in the present system and method. In fact, any other methods of converting time-domain into frequency domain signals may be used. As further illustrated in FIG. 8 once the frequency domain representation of each of the plurality of digital audio program samples is created then the spectral energy within each of the plurality of spectral bands for each of the plurality of digital program samples can be determined using the band plan that was created in association with FIG. 10. Each time interval (which is preferably selected to be eight (8) milliseconds (TI₁, TI₂, . . . , TIₙ)), has a plurality of spectral bands, which can be thought of as SB₁, SB₂, SB₃, etc through SBₙ. Then, by comparing the change in spectral flux in the bands between adjacent samples, A and B, (i.e. ASB₁-BSB₁, ASB₂-BSB₂, ASB₃-BSB₃, . . . , ASBₙ-BSBₙ) an array of Boolean values (i.e. F₁, F₂, F₃, . . . , Fₙ) can be created that indicates whether the spectral energy within each of the plurality of spectral bands increased between time intervals TIₓ and TIₓ₊₁. In other words, with reference to FIGS. 10 and 11, if the spectral energy in the first spectral band, SB₁ (beginning at 300 Hz) is higher in sample TIₓ₊₁ than in sample TIₓ then the number 1 is inserted into the array at F₁ associated with the time interval. As such, the audio program signal is represented with a predetermined number of Boolean arrays, which reflect the change in spectral flux in each of the spectral bands between adjacent time intervals in the original digital program sample.

In some embodiments, the absolute magnitude of the change in spectral flux in each spectral band (i.e. ASB₁-BSB₁, ASB₂-BSB₂, ASB₃-BSB₃, . . . , ASBₙ-BSBₙ) may also be used to create a confidence score, C₁, C₂, . . . , Cₙ for each comparison. Thus, if two spectral band flux values are close (i.e. there is a small change between sample A and sample B), the confidence score will be low. In this way, the confidence score, C, provides some indication of the potential impact noise may be having in each spectral band. In other words, if the difference between spectral bands is close, it is more likely that noise can skew the Booelan values. The plurality of resulting confidence scores can be used along with the Boolean values to represent the audio program. For example, if the Boolean values calculated do not match any data created from known media programs, then the Boolean values with associated confidence values below a predetermined threshold may be flipped (i.e. change 0 to 1 or 1 to 0) leaving Boolean values with associated confidence values above the threshold intact. Once having flipped the low-confidence values, then the resulting Boolean array can be checked again against the database of known media programs.

As indicated in FIG. 7, it is contemplated that the conversion from audio to audio fingerprint (i.e. calculation of the Boolean and Confidence Values (where such options values are selected for use)) may be performed local to the viewer or at a remote location, such as in association with a server or otherwise in the cloud. As would be understood by those of ordinary skill in the art having the present specification, drawings, and claims before them audio identification engine 150 will be capable for processing audio for a plurality of viewers in parallel. This is particularly true in the use case where the audio recognition/fingerprinting aspect of audio recognition engine 151 is deployed on computer 30 and/or smart phone 55. This use case will minimize the amount of data that is transmitted between the viewer and the remainder of the system 100, however, it may require the use of more sophisticated smart phones or run the risk of slower response times.

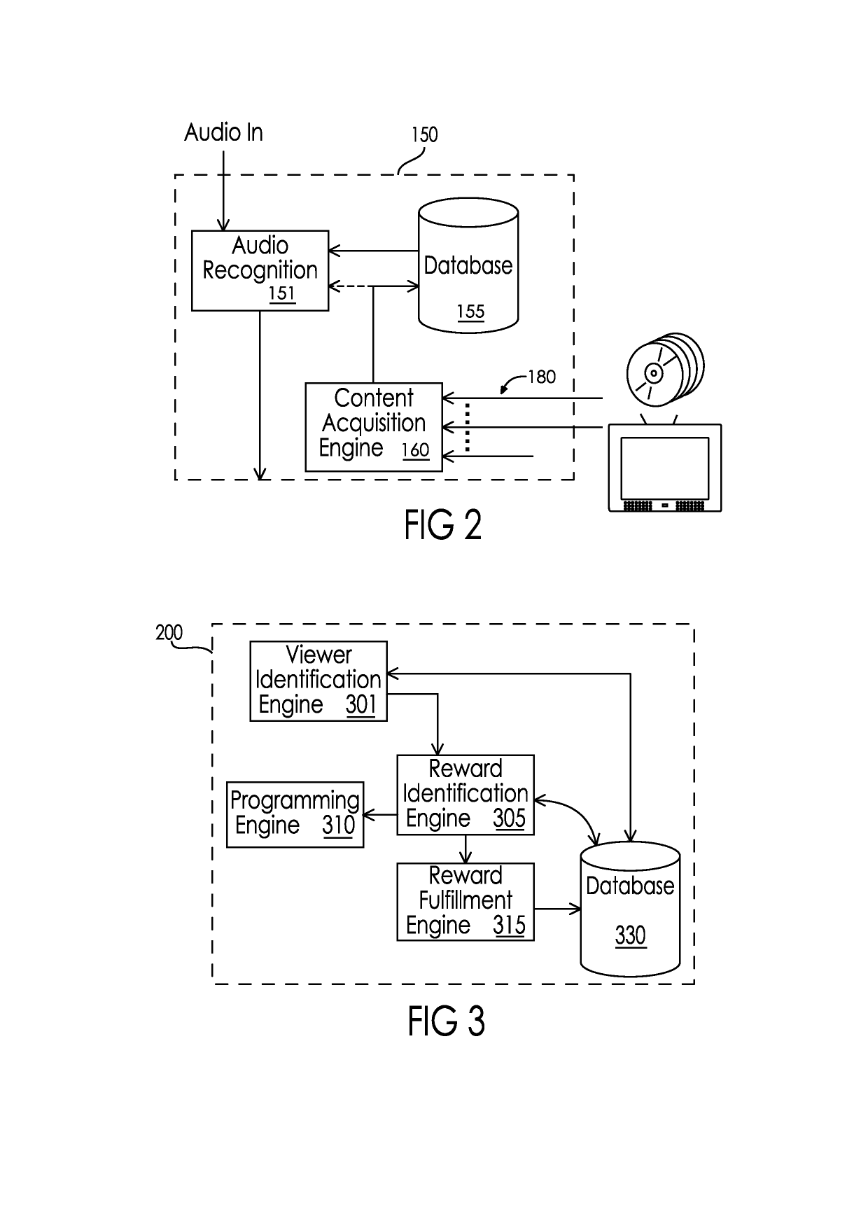

Ultimately, the audio identification engine 150 compares the Boolean arrays (or audio fingerprint) recorded by viewer actuation with audio fingerprints created using the same methodology but generated from known media programs. As shown in FIG. 2, the Boolean arrays created from known media and entertainment content may be rendered in real-time and/or may be created and stored in database 155 (along with textual data regarding the media and entertainment content, including but not limited to show title) by content acquisition engine 160 using the same system and methods of substantially identifying a media program disclosed herein.

As shown in FIG. 1, the audio identification engine 150 may send data regarding the media and entertainment content that the viewer 40 is presently experiencing to the viewer feedback engine 200. Viewer feedback engine 200 is illustrated in more detail in FIG. 3. In particular, viewer feedback engine 200 may include viewer identification engine 301, reward identification engine 305, programming engine 310, reward fulfillment engine 315, and database 330. When the viewer launches the application for the first time, viewer identification engine 301 is responsible for creating the viewer account. And then, the viewer identification engine 301 interacts with viewer 40 via the computer software 110 to obtain identification information regarding the viewer 40.

The data collected by viewer identification engine 310 may be stored in database 330. While database 330 is depicted as a single database, it should be understood by those of ordinary skill in the art having the present specification, drawings, and claims before them that the database 330 may be stored in multiple locations and across multiple pieces of hardware, including but not limited to storage in the cloud. In view of the sensitive data stored in database 330, it will be secured in an attempt to minimize the risk of undesired disclosure of viewer information to third parties.

FIG. 7 illustrates one potential flow for interaction of viewer 40 with the system. As illustrated in FIG. 7, when a viewer logs into the system they may be immediately checking into a media or entertainment show. FIG. 6 provides an illustration of a screen that could appear following a successful check in of the viewer 40 by the audio identification engine 150. As illustrated, the screen may provide feedback based on the check in. For instance, an associated system may award the viewer points (i.e. 50 points) because the viewer checked into a particular media or entertainment program.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A method of substantially identifying a media program from its associated audio program signal, the audio program signal being a substantially continuous time-domain signal generally having a range of frequencies normally audible to humans, the method comprising:
dividing a substantial portion of the range of human-audible frequencies in a quasi-logarithmic fashion into a plurality of spectral bands;
recording a segment of predetermined length from the audio program signal at a predetermined interval to obtain a plurality of analog audio program samples, the predetermined interval being a fraction of the predetermined length;
converting each of the plurality of analog audio program samples to a plurality of digital audio program samples at a first sampling rate;
creating a frequency domain representation of each of the plurality of digital audio program samples;
determining spectral energy within each of the plurality of spectral bands for each of the plurality of digital program samples;
reflecting whether the spectral energy within each of the plurality of spectral bands went up between adjacent ones of the plurality of digital program samples as a Boolean array; and
representing the audio program signal with a predetermined number of Boolean arrays.

2. The method of claim 1 further comprising:
calculating a confidence score for each value in the Boolean array, wherein the confidence score is a function of the difference between adjacent spectral energy values; and
further representing the audio program signal with the confidence score.

3. The method of claim 2 further comprising
comparing a portion of the predetermined number of Boolean arrays to arrays created from a plurality of media programs until the media program is found; and
flipping a value within the Boolean arrays where the confidence score associated with the value is below a predetermined threshold and the media program has not been found.

4. The method of claim 3 wherein creating a frequency domain representation comprises calculating a Fast Fourier Transform from each of the digital audio program samples.

5. The method of claim 4 wherein the substantial portion of the range of human-audible frequencies is 300 Hz to 4 kHz.

6. The method of claim 5 wherein the segment of predetermined length is 1 second and the predetermined interval is 8 milliseconds.

7. The method of claim 6 wherein the first sampling rate is 48 kHz, the method further including down-sampling the plurality of digital audio program samples to a second sampling rate.

8. The method of claim 7 wherein the second sampling rate is 8 kHz.

9. The method of claim 1 further comprising comparing a portion of the predetermined number of Boolean arrays to arrays created from a plurality of media programs until the media program is found.

10. A system for substantially identifying a media program from its associated audio program signal, the audio program signal being a substantially continuous time-domain signal generally having a range of frequencies normally audible to humans, the system comprising:
means for dividing a substantial portion of the range of human-audible frequencies in a quasi-logarithmic fashion into a plurality of spectral bands;
an audio segment recorder for recording a segment of predetermined length from the audio program signal at a predetermined interval to obtain a plurality of analog audio program samples, the predetermined interval being a fraction of the predetermined length;
an analog-to-digital converter to convert each of the plurality of analog audio program samples to a plurality of digital audio program samples at a first sampling rate;
means for creating a frequency domain representation of each of the plurality of digital audio program samples; and
means for reflecting as a Boolean array whether the spectral energy within each of the plurality of spectral bands for each of the plurality of digital program samples increased between adjacent ones of the plurality of digital program samples.

11. The system of claim 10 further comprising means for calculating a confidence score for each value in the Boolean array as a function of the difference between adjacent spectral energy values and for storing the confidence score in association with the Boolean array.

12. The system of claim 11 further comprising:
means for comparing a portion of the Boolean arrays to arrays created from a plurality of media programs until the media program is found; and
means for flipping a value within the Boolean arrays where the confidence score associated with the value is below a predetermined threshold and the media program has not been found.

13. The system of claim 12 wherein the means for creating the frequency domain representation comprises calculating a Fast Fourier Transform from each of the digital audio program samples.

14. The system of claim 10 further comprising means for comparing a portion of the Boolean arrays to arrays created from a plurality of media programs until the media program is found.
